(19) United States
(12) Patent Application Publication
(10) Pub. No.: US 2016/0143030 A1
(43) Pub. Date: May 19, 2016

(54) METHOD OF TRANSMITTING FRAME FOR SUPPORTING LEGACY SYSTEM, AND METHOD AND APPARATUS OF SEARCHING CELL USING THE SAME

(71) Applicant: ELECTRONICS AND TELECOMMUNICATIONS RESEARCH INSTITUTE, Daejeon (KR)

(72) Inventors: Anseok LEE, Daejeon (KR); Seungkwon CHO, Daejeon (KR); Soojung JUNG, Daejeon (KR); Sung Cheol CHANG, Daejeon (KR); Keunyoung KIM, Anyang-Si (KR); Seokki KIM, Daejeon (KR)

(73) Assignee: ELECTRONICS AND TELECOMMUNICATIONS RESEARCH INSTITUTE, Daejeon (KR)

(21) Appl. No.: 14/940,642

(22) Filed: Nov. 13, 2015

(30) Foreign Application Priority Data
Nov. 14, 2014 (KR) 10-2014-0159192
Nov. 14, 2014 (KR) 10-2014-0159193
Jun. 4, 2015 (KR) 10-2015-0079432
Nov. 12, 2015 (KR) 10-2015-0158965
Nov. 12, 2015 (KR) 10-2015-0158967

(51) Int. Cl. H04W 72/04; H04W 56/00; H04L 1/18; H04W 72/00

(52) U.S. Cl. CPC H04W 72/0446; H04W 72/005; H04W 72/0453; H04W 56/0005; H04L 1/1812; H04W 88/02

(57) ABSTRACT

Disclosed herein are a method of transmitting a frame for supporting a legacy system, and a method and an apparatus of searching a cell using the same. A frame including a first frequency band for supporting a mobile communication system and a second frequency band for supporting a legacy system and having a total frequency band larger than the second frequency band is generated. Primary broadcasting information related to a frequency bandwidth is transmitted through a broadcasting physical channel of the second frequency band.

### CROSS-REFERENCE TO RELATED APPLICATION

This application claims priority to and the benefit of Korean Patent Application Nos. 10-2014-0159192, 10-2014-0159193, 10-2015-0079432, 10-2015-0158965, and 10-2015-0158967 filed in the Korean Intellectual Property Office on Nov. 14, 2014, Nov. 14, 2014, Jun. 4, 2015, Nov. 12, 2015, and Nov. 12, 2015, the entire contents of which are incorporated herein by reference.

### BACKGROUND OF THE INVENTION

(a) Field of the Invention

The present invention relates to a method of transmitting a frame for supporting a legacy system in a wireless communication system, and a method and an apparatus of searching a cell using the same.

(b) Description of the Related Art

In a mobile communication environment, there is a legacy zone (L-zone) support method as a legacy technology for supporting a legacy system in a new system. Here, the legacy system indicates a system that has been already defined, and a legacy terminal indicates a terminal supported by the legacy system. For example, in terms of a 3GPP LTE-A system, a 3GPP LTE system corresponds to the legacy system.

As a method of supporting the legacy system in a wireless communication system, there is a method of dividing a downlink (DL) zone into legacy zones, which are regions supporting the legacy terminal, and new zones, which are regions supporting a terminal of a new system, through a time division multiplexing scheme.

In this frame structure, a time interval for supporting the legacy system is inevitably generated between the new zones. Therefore, a minimum access time in a service for low latency is increased. In addition, basically, the respective systems may access only zones allocated to the respective systems, such that it is difficult to satisfy a dynamic service demand.

### SUMMARY OF THE INVENTION

The present invention has been made in an effort to provide a method of transmitting a frame, and a method and terminal of searching a cell using the same having advantages of supporting a legacy system operated in an existing frame structure in a system supporting new services such as low latency services.

The present invention has also been made in an effort to provide a method and an apparatus of generating and transmitting a frame for low latency services in a mobile communication system supporting a new service such as the low latency service.

An exemplary embodiment of the present invention provides a method of transmitting a frame supporting a legacy system in a mobile communication system. The method includes generating a frame including a first frequency band for supporting the mobile communication system and a second frequency band for supporting the legacy system and having a total frequency band larger than the second frequency band; and transmitting primary broadcasting information through a broadcasting physical channel of the second frequency band.

The primary broadcasting information may include a legacy system bandwidth and a total frequency bandwidth, and the method may further include transmitting secondary broadcasting information through a data region of the second frequency band, wherein the secondary broadcasting information may include band configuration information of the mobile communication system. The method may further include setting some of subframes of the second frequency band so as not to be used by a terminal accessing the legacy system and setting some of the subframes of the second frequency band so as to be used for a terminal requesting low latency services of the mobile communication system, wherein the setting may include constraining an operation of the terminal accessing the legacy system in some of the subframes through a multimedia broadcast single frequency network (MBSFN) subframe configuration or an almost blank subframe (ABS) configuration in a downlink frame of the legacy system of the second frequency band; and constraining uplink transmission scheduling of the terminal accessing the legacy system in some of the subframes in an uplink frame of the legacy system of the second frequency band to use resources for a service of a terminal of the mobile communication system.

The frame of the mobile communication system may be configured in a transmission time interval (TTI) structure shorter than that of a frame of the legacy system, some of radio resources configuring each TTI of the first frequency band may be used as control regions, and the control regions may have a predetermined size or have sizes different from each other per TTI.

The primary broadcasting information may include indication information for indicating that a size of the control region is fixed or varied, and the indication information on the size of the control region may be transmitted through a short physical control format indicator channel (sPCFICH) in the case in which the size of the control region is varied, and when a period in which the size of the control region may be varied is larger than one TTI size, the sPCFICH, may be configured once per corresponding period, and the primary broadcasting information may include information on the period in which the size of the control region is varied.

The size of the control region may be determined by control format indicator (CFI) information, and indicate one of the number of radio resources configuring the control region, a ratio of radio resources occupied by the control region to total radio resources, and a maximum size of the radio resources occupied by the control region.

Radio resources to which the sPCFICH is to be mapped may be selected, the sPCFICH may be allocated to a plurality of radio resources from a first radio sources among the selected radio resources, a channel other than the sPCFICH may be allocated to the other of the selected radio resources, and the channel other than the sPCFICH may include one of a hybrid automatic repeat request (HARQ) indication channel (short physical HARQ indicator channel (sPHICH)) and a short physical downlink control channel (sPDCCH).

Another exemplary embodiment of the present invention provides a method of searching a cell by a terminal in a mobile communication system supporting a legacy system. The method includes the terminal receiving primary broadcasting information through a broadcasting physical channel of a second frequency band in a structure in which a frame includes a first frequency band for supporting the mobile communication system and the second frequency band for supporting the legacy system; the terminal receiving system information through control and data regions of the first frequency band on the basis of the primary broadcasting information; and performing an access to the mobile communication system on the basis of the received system information.

The primary broadcasting information may include a legacy system bandwidth and a total frequency bandwidth, and the method may further include after the receiving of the primary broadcasting information, calculating a bandwidth of the mobile communication system on the basis of the legacy system bandwidth and a total system bandwidth; and adjusting the total system bandwidth on the basis of the calculated bandwidth of the mobile communication system and the legacy system bandwidth.

In the case in which both of the legacy system bandwidth and the total system bandwidth are odd numbers or are even numbers, the total system bandwidth included in the primary broadcasting information and the adjusted total system bandwidth may have the same value, and in the case in which one of the legacy system bandwidth and the total system bandwidth is an odd number or the other thereof is an even number, the adjusted total system bandwidth may have a value smaller than that of the total system bandwidth included in the primary broadcasting information by 1.

The method may further include before the receiving of the primary broadcasting information, the terminal receiving a legacy synchronization signal or a mobile communication system synchronization signal to perform synchronization; and after the performing of the access, receiving secondary broadcasting information through control and data regions of the second frequency band, the second broadcasting information including setting information of the mobile communication system.

Yet another exemplary embodiment of the present invention provides a terminal in a mobile communication system supporting a legacy system. The terminal includes a radio frequency (RF) converter transmitting and receiving signals through an antenna; and a processor connected to the RF converter and performing a cell search, wherein the processor includes a primary broadcasting information processor for receiving and processing primary broadcasting information through a broadcasting physical channel of a second frequency band in a structure in which a frame includes a first frequency band for supporting the mobile communication system and the second frequency band for supporting the legacy system; and an access processor for receiving system information through control and data regions of the first frequency band on the basis of the primary broadcasting information and performing an access on the basis of the received system information.

The primary broadcasting information may include a legacy system bandwidth and a total frequency bandwidth, and the processor may further include a bandwidth processing unit for calculating a bandwidth of the mobile communication system on the basis of the legacy system bandwidth and the total frequency bandwidth and adjusting a total system bandwidth on the basis of the calculated bandwidth of the mobile communication system and the legacy system bandwidth.

The processor may further include a synchronization processor for receiving a legacy synchronization signal or a mobile communication system synchronization signal to perform synchronization, before the primary broadcasting information is received; and a secondary broadcasting information processor for receiving and processing secondary broadcasting information through control and data regions of the second frequency band, the second broadcasting information including setting information of the mobile communication system.

Yet another exemplary embodiment of the present invention provides a method of transmitting a frame in a mobile communication system supporting low latency services. The method includes generating a frame in which some of resources of a legacy system band, which is a frequency band for supporting a legacy system, are allocated to a low latency region for the low latency service; and transmitting information on the low latency region.

The low latency region may be configured in a short-transmission time interval (TTI) structure, and be allocated in a subframe unit of the legacy system band, and a final short frame of short frames configuring the low latency region having the short-TTI structure may be configured of symbols less than those of other short frames or a first short frame of the short frames configuring the low latency region having the short-TTI structure may be configured of symbols less than those of other short frames.

The transmitting of the information may include at least one of: transmitting the information on the low latency region through a control region of the legacy system band; and transmitting the information on the low latency region through higher layer signaling.

The method may further include allocating some of the low latency region as a control region for control information transmission of a low latency terminal; and allowing configuration information on the control region of the low latency region to be included in configuration information of the low latency region. The method may further include allocating some of the low latency region as a data region for data transmission of a low latency terminal; and transmitting information on the data region through control signaling of the low latency region.

The method may further include performing HARQ feedback through a control region or a data region of the legacy system band in the case in which resources for performing a HARQ procedure in the low latency region are insufficient at the time of performing the HARQ feedback of a transport block transmitted through the data region.

### BRIEF DESCRIPTION OF THE DRAWINGS

FIG. 1 is a view showing a frame structure of a legacy system.

FIG. 2 is a view showing a frame structure of a mobile communication system supporting low latency services.

FIG. 3 is a view showing different frame structures of a low latency system.

FIG. 4 is a view showing a frame structure depending on asymmetric frequency division duplexing (FDD).

FIG. 5 is a view showing a basic frame structure according to an exemplary embodiment of the present invention.

FIG. 6 is a view showing bandwidths of systems according to an exemplary embodiment of the present invention.

FIG. 7 is a flow chart showing a cell searching procedure of a low latency terminal according to an exemplary embodiment of the present invention.

FIG. 8 is a flow chart showing another cell searching procedure of a low latency terminal according to an exemplary embodiment of the present invention.

FIG. 9 is an illustrative view showing a structure in which a legacy region is varied in a frame according to an exemplary embodiment of the present invention.

FIG. 10 is an illustrative view showing a downlink frame structure in which a legacy region is varied according to an exemplary embodiment of the present invention, and

FIG. 11 is an illustrative view showing an uplink frame structure in which a legacy region is varied according to an exemplary embodiment of the present invention.

FIG. 12 is an illustrative view showing a configuration of a control region of a low latency system according to an exemplary embodiment of the present invention.

FIG. 13 is an illustrative view showing mapping of a position of a channel (sPCFICH) indicating a size of a control region according to an exemplary embodiment of the present invention.

FIG. 14 is a view showing a control region and resource allocation in a system according to an exemplary embodiment of the present invention.

FIG. 15 is an illustrative view showing synchronization signals and physical channel transmission and in a system according to an exemplary embodiment of the present invention.

FIG. 16 is an illustrative view showing transmission of a hybrid automatic repeat request (HARQ) retransmission time in a system according to an exemplary embodiment of the present invention.

FIG. 17 is a block diagram of a terminal according to an exemplary embodiment of the present invention.

FIG. 18 is a view showing a frame structure in a low latency system according to another exemplary embodiment of the present invention.

FIG. 19 is a view showing examples of a low latency region and a PDCCH region according to another exemplary embodiment of the present invention.

FIG. 20 is a view showing another examples of a low latency region and a PDCCH region according to another exemplary embodiment of the present invention.

FIGS. 21 and 22 are views showing yet another examples of a low latency region and a PDCCH region according to another exemplary embodiment of the present invention.

FIG. 23 is a view showing an example of allocating a short-TTI region for a low latency system on the basis of a legacy system band in another exemplary embodiment of the present invention.

FIG. 24 is an illustrative view showing a downlink frame structure according to another exemplary embodiment of the present invention, and

FIG. 25 is an illustrative view showing an uplink frame structure according to another exemplary embodiment of the present invention.

FIG. 26 is an illustrative view showing resource allocation for data transmission in a frame structure according to another exemplary embodiment of the present invention.

FIG. 27 is a flow chart of a method of transmitting a frame according to another exemplary embodiment of the present invention.

FIG. 28 is a view showing HARQ feedback in a low latency region according to another exemplary embodiment of the present invention.

FIG. 29 is a block diagram of an apparatus of transmitting a frame according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, unless explicitly described to the contrary, the word “comprise” and variations such as “comprises” or “comprising”, will be understood to imply the inclusion of stated elements but not the exclusion of any other elements.

Throughout the present specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), a user equipment (UE), or the like, and may include all or some of functions of the MT, the MS, the AMS, the HR-MS, the SS, the PSS, the AT, the UE, or the like.

Hereinafter, a method of transmitting a frame for supporting a legacy system, and a method and an apparatus of searching a cell using the same according to an exemplary embodiment of the present invention will be described with reference to the accompanying drawings.

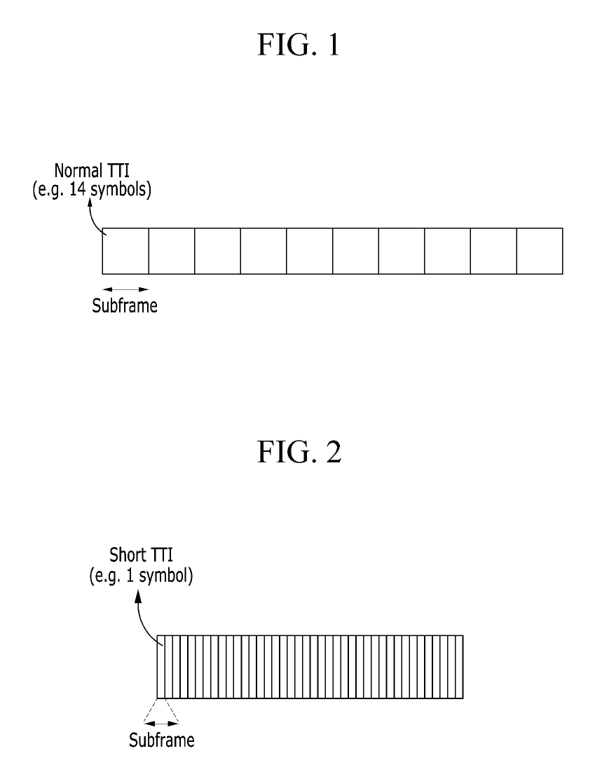

FIG. 1 is a view showing a frame structure of a legacy system.

A frame of a legacy system (which is also referred to as a “legacy frame for convenience of explanation) includes a plurality of subframes, as shown in FIG. 1, and is configured in a normal transmission time interval (TTI) structure. Each of the subframes configuring TTI includes, for example, about fourteen orthogonal frequency division multiplexing (OFDM) symbols including two groups of seven slots. Here, the legacy system indicates a system that has been already defined.

FIG. 2 is a view showing a frame structure of a mobile communication system supporting low latency services.

A system supporting a new service, for example, a mobile communication system (hereinafter, referred to as a low latency system for convenience of explanation) supporting low latency services is configured in a short TTI structure for the purpose of a short transmission time, as illustrated in FIG. 2. The respective subframes configuring the TTI, that is, short frames may be configured of, for example, at least about 100 us, and may be configured of one symbol. The TTI of the low latency system is, for example, 100 us, which is a time decreased to 1/10 of a TTI of 1 ms of the legacy system (for example, a 3GPP LTE/LTE-A system). Basically, since a terminal accessing the mobile communication system needs to perform control information reception per transmission time unit, the number of times of control information reception that needs to be performed by a system using a short transmission time unit of 1/10 is 10.

The low latency system uses the same OFDM symbols as those of the legacy system in order to prevent interference between the low latency system and the legacy system and ensure minimum compatibility, and the number of OFDM symbols configuring the TTI may be determined by a time constraint of the TTI. For example, the TTI may be configured of one symbol. In addition to the TTI configured of one symbol, the TTI may be variously configured of two to seven symbols.

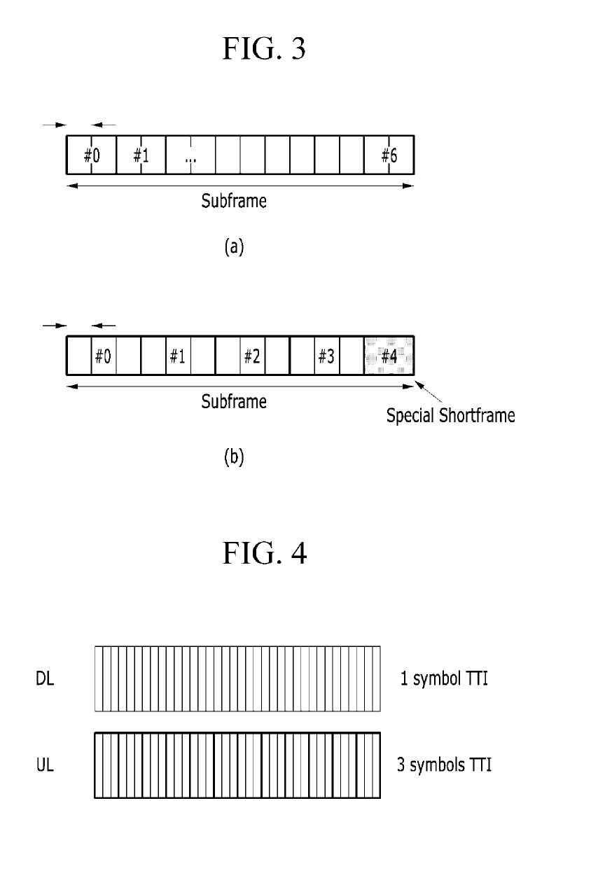

FIG. 3 is a view showing different frame structures of a low latency system.

In a frame structure of the low latency system, there may be a TTI configured of two symbols or three symbols in addition to the TTI configured of one symbol, as illustrated in FIG. 3. In (a) of FIG. 3, each TTI is configured of two symbols. In addition, in (b) of FIG. 3, 0^{th}, 1^{st}, 2^{nd}, and 3^{rd}, TTIs are configured of three symbols.

As described above, in the case in which the TTIs are configured of the two symbols or the three symbols, it is likely that the TTIs will not be configured so as to accord with the subframe configured of fourteen symbols, as illustrated in FIGS. 3A and 3B. That is, as illustrated in (b) of FIG. 3, in the case in which the TTIs are configured of the three symbols in the subframe configured of the fourteen symbols, one or two extra symbols are present. These extra symbols may be called a special short frame. The special short frame may be utilized for a specific purpose such as data transmission, control signaling, or the like.

Since the number of symbols included in the special short frame is less than that of symbols included in the short frame, in the case in which the special short frame is used for the data transmission, the data transmission needs to be performed using resources less than those of the short frame. Therefore, these resources may be used for a terminal having a good channel environment or data transmission having a small size. Furthermore, these resources may be used for transmission of hybrid automatic repeat request (HARQ) feedback, scheduling information, channel state information, a sounding reference signal for the channel state information, or the like.

Meanwhile, in a frequency division duplexing (FDD) environment, a downlink (DL) and an uplink (UL) may be operated in different TTI units. This may be called asymmetric FDD. As an example in which the asymmetric FDD is utilized, a TTI of a UL frame is configured of more symbols than those of a TTI of a DL frame to enable transmission using larger energy at the time of transmitting control information or data information, thereby making it possible to solve a coverage problem of the uplink.

FIG. 4 is a view showing a frame structure depending on asymmetric FDD.

A DL frame and a UL frame shown in FIG. 4 are operated in different TTI units. In detail, in a DL environment, a frame is operated in a one-symbol TTL unit, and in a UL environment, a frame is operated in a three-symbol TTI unit. In this asymmetric FDD environment, a DL TTI and a UL TTI need to be separately defined, which is transferred as broadcasting information (e.g., a master information block or a system information block (SIB)), or the like, to a terminal.

In an exemplary embodiment of the present invention, in order to support the legacy system in the low latency system, which is a system providing a new service, for example, low latency services, a new frame structure in which a frame structure configured of the short frame TTI as described above and a frame structure of the legacy system are integrated with each other is used.

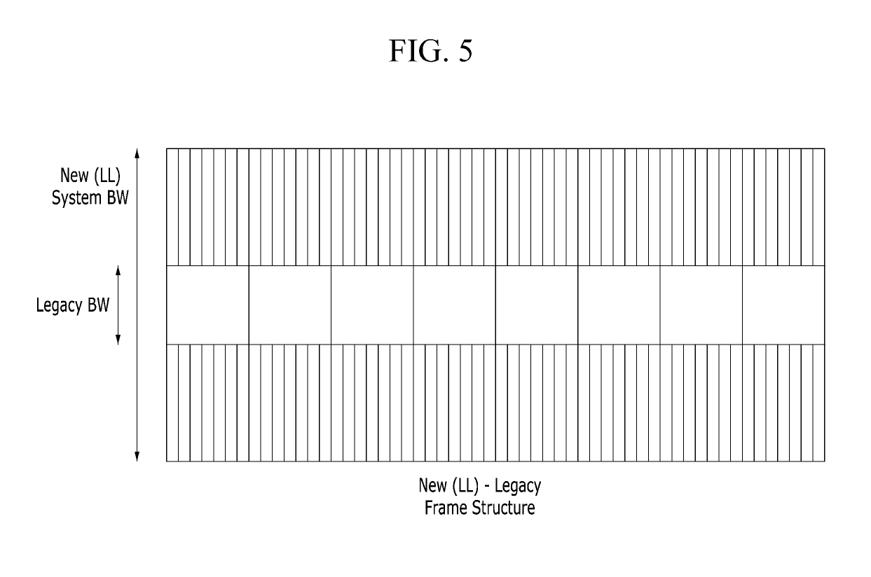

FIG. 5 is a view showing a basic frame structure according to an exemplary embodiment of the present invention.

A frequency bandwidth of the low latency system according to an exemplary embodiment of the present invention is configured to be larger than that of the legacy system. As shown in FIG. 5, a new frame of the low latency system according to an exemplary embodiment of the present invention includes a region (referred to as a low latency region for convenience of explanation) for supporting the low latency system and a region (referred to as a legacy region for convenience of explanation) for supporting the legacy system. That is, a frequency band of the legacy system is configured in some of a total bandwidth of the frame. Therefore, the total frequency bandwidth of the low latency system needs to be configured to be larger than a frequency bandwidth of the legacy system.

Terminals that intend to access the legacy system may obtain system information through a synchronization signal and a broadcasting physical channel in the frequency band of the legacy system, and the system information such as the bandwidth, and the like, is transferred on the basis of the legacy system. The terminals accessing the legacy system may recognize the total frequency band as the frequency band of the legacy system, and then perform the operation of a legacy terminal.

Among terminals accessing a system in which the low latency system and the legacy system coexist with each other, terminals (referred to as low latency terminals for convenience of explanation) that intend to access the low latency system need to be able to configure a bandwidth of the low latency system on the basis of information transmitted in the legacy system.

In order for the low latency terminals to configure the bandwidth of the low latency system, a method of using primary broadcasting information and a method of using secondary broadcasting information may be used.

The primary broadcasting information is information transmitted on a broadcasting physical channel of the frequency band of the legacy system, that is, a physical broadcasting channel (PBCH), has a form such as a master information block (MIB), and is information that the terminal may know before the terminal accesses the system. The low latency terminal receives a legacy system bandwidth (N_System) and a total system bandwidth (N_Total) in the MIB, which is the primary broadcasting information of the legacy system. A unit of each bandwidth information is the number of configured resource blocks (RBs). A legacy system bandwidth and a low latency system bandwidth using the received two information may be calculated as follows.

N^{DL}^{_}^{Legacy}_{RB}=N^{DL}^{_}^{System}_{RB}

N^{DL}_{sRB}=floor((N^{DL}^{_}^{total}_{RB}−N^{DL}^{_}^{Legacy}_{RB})/2)*2 [Equation 1]

Here, N^{DL}^{_}^{Legacy}_{RB} indicates the legacy system bandwidth on the downlink, and N^{DL}^{_}^{System}_{RB} indicates the low latency system bandwidth on the downlink. N^{DL}^{_}^{total}_{RB} indicates a total system bandwidth on the downlink. N^{DL}_{sRB} indicates the low latency system bandwidth calculated on the basis of the legacy system bandwidth and the total system bandwidth.

The total system bandwidth is adjusted on the basis of the low latency system bandwidth N^{DL}_{sRB} and the legacy system bandwidth N^{DL}^{_}^{Legacy}_{RB} calculated on the basis of the above Equation 1 to obtain an adjusted total system bandwidth N_Total′ as follows.

N^{DL}^{_}^{Total′}_{RB}=N^{DL}_{sRB}+N^{DL}^{_}^{Legacy} [Equation 2]

In the above Equation 2, the received total system bandwidth N_Total and the adjusted system bandwidth N_Total′ are the same as each other in the case in which both of the received legacy system bandwidth N_System and total system bandwidth N_Total are odd numbers or both of the received legacy system bandwidth N_System and total system bandwidth N_Total are even numbers. In addition, in the case in which the legacy system bandwidth N_System is an odd number and the total system bandwidth N_Total is an even number or in the case in which the legacy system bandwidth N_System is an even number and the total system bandwidth N_Total is an odd number, the adjusted total system bandwidth N_Total′ is determined to be a value smaller than the received total system bandwidth N_Total by 1. This is due to a constraint depending on RB dispositions of the legacy system. This constraint is generated since the RB dispositions need to be the same as each other regardless of a size of the bandwidth of the low latency system when the terminals that intend to access the legacy system intend to access the legacy system using a central frequency and the bandwidth of the legacy system.

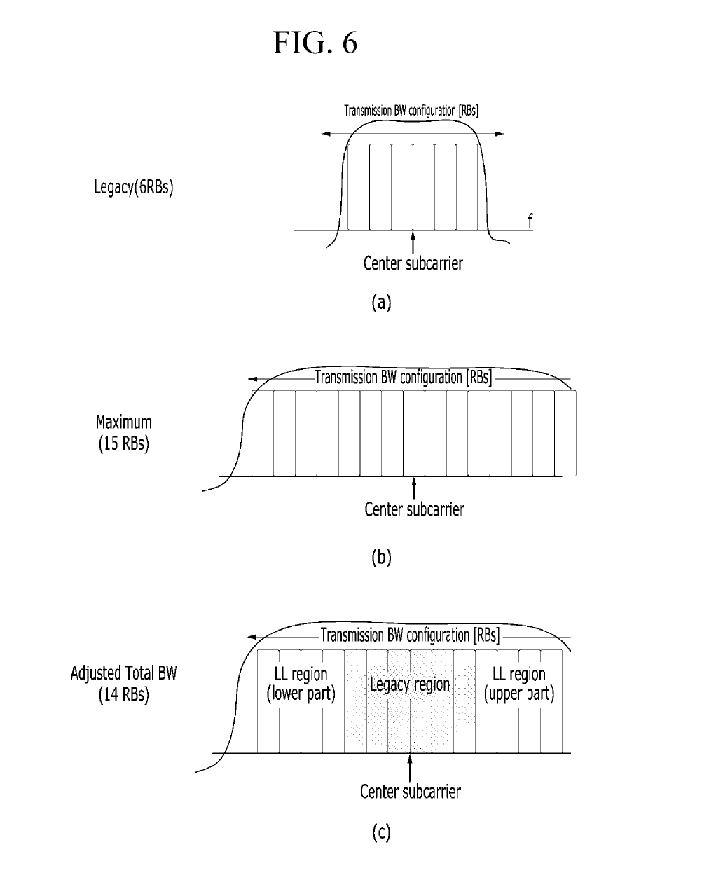

FIG. 6 is a view showing bandwidths of systems according to an exemplary embodiment of the present invention.

In the case in which the legacy system bandwidth N_System is 6 RBs as shown in (a) of FIG. 6 and the total system bandwidth N_Total is 15 RBs as shown in (b) of FIG. 6, the adjusted total system bandwidth N_Total′ needs to be 14RBs as shown in (c) of FIG. 6 in order to maintain an RB configuration of the legacy system bandwidth. RBs of a low latency system band (that may also be referred to as a low latency region) in the adjusted total system bandwidth may be configured to be equal to each other in upper and lower parts in relation to a band in which RBs of the legacy system are configured, as illustrated in (c) of FIG. 6.

The secondary broadcasting information has a form such as a system information block (SIB) transmitted through a data region (physical downlink shared channel (PDSCH) of the frequency band of the legacy system, and is information that may be received after accessing the system.

The low latency terminal may access the legacy system and then receive SIB information related to a low latency system band configuration through a data region of the legacy system. The low latency system band configuration information is, for example, information on a band of the low latency system represented by the number of RBs.

Meanwhile, the band of the legacy system may be configured in some frequency band of a total system band or may not be configured. In the case in which the band of the legacy system is not configured, the total system frequency bandwidth is used for the low latency system.

In the case in which the band of the legacy system is not configured, the legacy terminal may not be supported. In this case, an access of the legacy terminal needs to become impossible. In order to make the access of the legacy terminal impossible, different types of synchronization signals may be used. This will be described in more detail later.

In the case in which the band of the legacy system is not configured, the total system band is used for the low latency system, and a procedure of adjusting the total system band in consideration of the band (indicating a legacy region) of the legacy system is not required. In this case, N^{DL}_{sRB}=N^{DL}^{_}^{total}_{RB}.

Next, a cell searching procedure of a low latency terminal will be described.

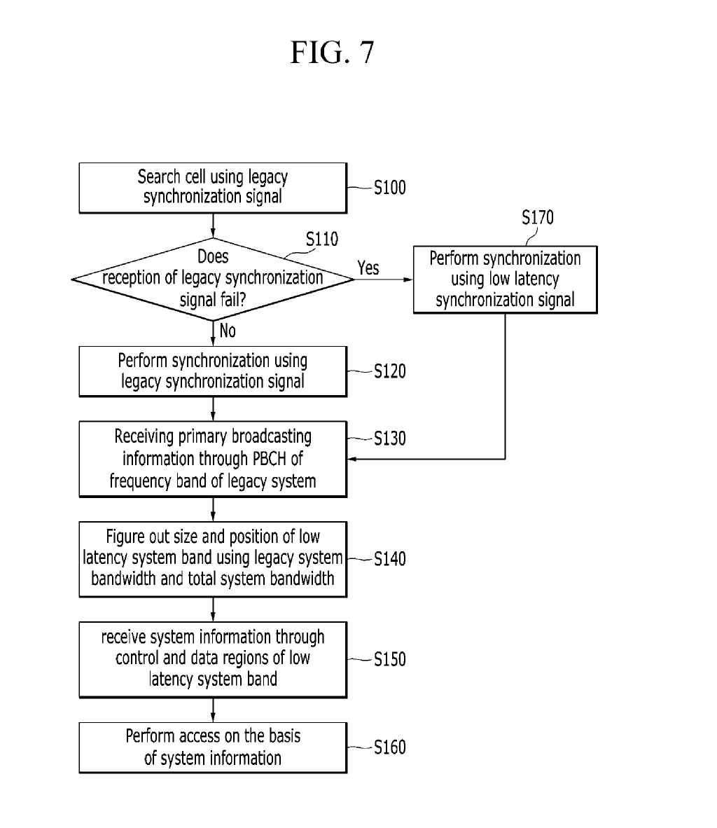

FIG. 7 is a flow chart showing a cell searching procedure of a low latency terminal according to an exemplary embodiment of the present invention.

Here, an example in which the low latency terminal performs a cell search in the case in which low latency system band information is transferred using the primary broadcasting information will be described.

First, the low latency terminal performs a cell search using a legacy synchronization signal and a broadcasting channel, and receives the primary broadcasting information (S100), as shown in FIG. 7. The primary broadcasting information is transmitted through the PBCH of the frequency bandwidth of the legacy system.

The low latency terminal is synchronized using the legacy synchronization signal (S110 and S120). Then, when the primary broadcasting information is received, a size and a position of a low latency system band are figured out using the legacy system bandwidth and the total system bandwidth of the primary broadcasting information (S130 and S140). Next, the low latency terminal receives system information through control and data regions of the low latency system band (S150), and performs the next access procedure on the basis of the received system information (S160).

Meanwhile, in the case in which the low latency terminal fails to receive the legacy synchronization signal, it receives a new synchronization signal, that is, a synchronization signal for the low latency system, and the primary broadcasting information. In addition, the low latency terminal is synchronized using the low latency synchronization signal (S170). In addition, as described above, the size and the position of the low latency system band are figured out on the basis of the primary broadcasting information received through the frequency band of the legacy system, and the access procedure is performed on the basis of the system information received through the control and data regions of the low latency system band (S130 to S160).

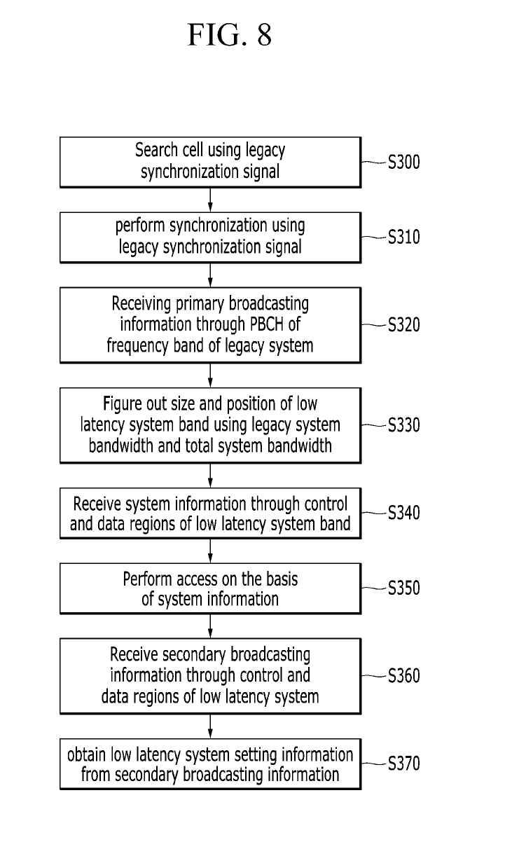

FIG. 8 is a flow chart showing another cell searching procedure of a low latency terminal according to an exemplary embodiment of the present invention.

Here, an example in which the low latency terminal performs a cell search in the case in which low latency system band information is transferred using the secondary broadcasting information will be described.

First, the low latency terminal performs a cell search using a legacy synchronization signal and a broadcasting channel, and receives the primary broadcasting information, as shown in FIG. 8. The primary broadcasting information is transmitted through the PBCH of the frequency band of the legacy system.

The low latency terminal is synchronized using the legacy synchronization signal. Then, when the primary broadcasting information is received, a size and a position a low latency system band are figured out using the legacy system band and the total system band of the first broadcasting information (S300 to S330). Next, the low latency terminal receives system information through control and data regions of the low latency system band, and performs the next access procedure on the basis of the received system information (S340 and S350).

In addition, the low latency terminal receives low latency system setting information, which is the secondary broadcasting information, through control and data regions of the legacy system band. The low latency system setting information may include the low latency system band information (S360 and S370).

Meanwhile, in the frame according to an exemplary embodiment of the present invention, the legacy system band, that is, the legacy region may be varied.

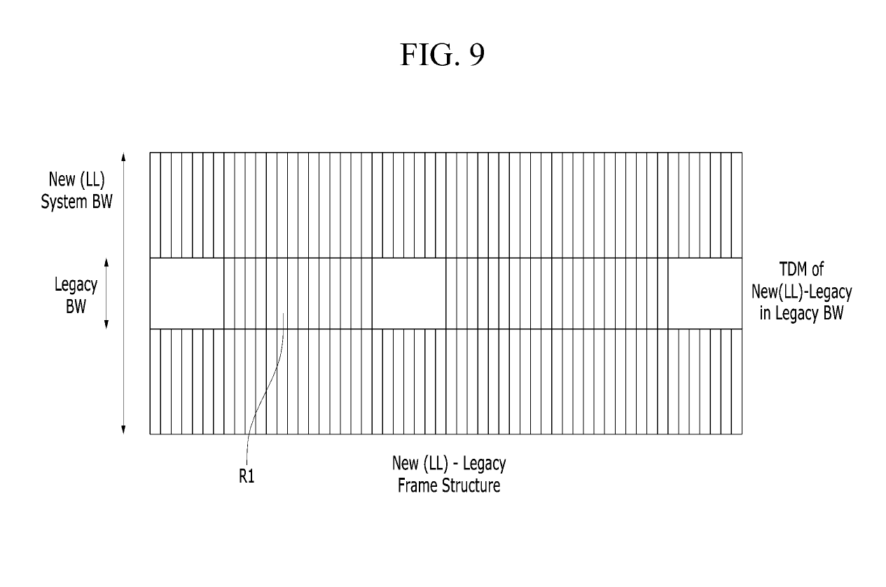

FIG. 9 is an illustrative view showing a structure in which a legacy region is varied in a frame according to an exemplary embodiment of the present invention.

It is required to dynamically vary a resource region of the low latency system and a resource region of the legacy system in consideration of loads of terminals accessing each of the low latency system and the legacy system in a cell. For this purpose, the legacy system band for supporting the legacy system may be adjusted to adjust a size of the resource for the terminals accessing each system.

For example, as shown in FIG. 9, some R1 of subframes of the legacy system band, that is, the legacy region may be set so as not to be used by the terminals accessing the legacy system, that is, the legacy terminals, but may be set so as to be used by terminals requesting low latency services. As described above, a method of allowing some of the subframes not to be used may be implemented by applying a multimedia broadcast single frequency network (MBSFN) subframe configuration method, an almost blank subframe (ABS) configuration method of the legacy system, or the like.

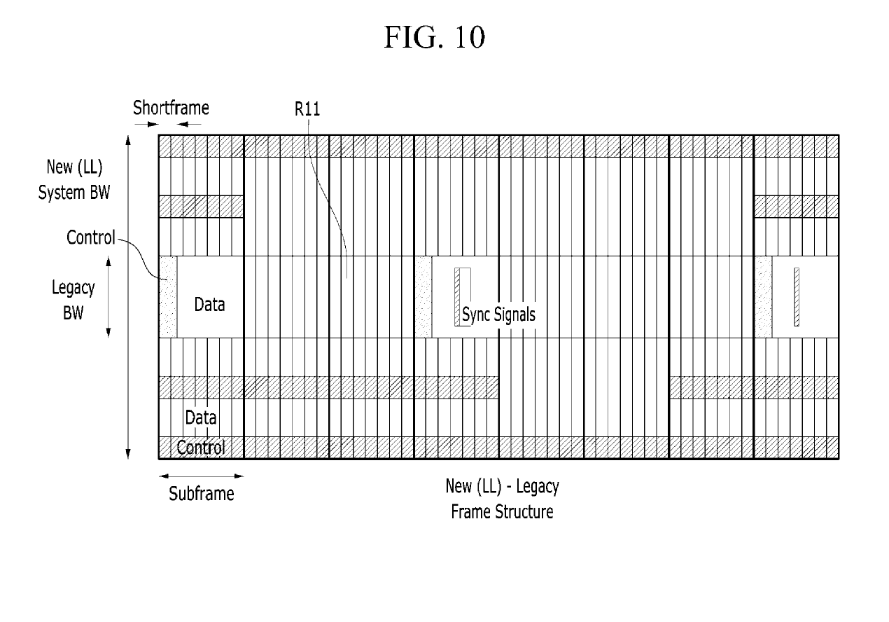

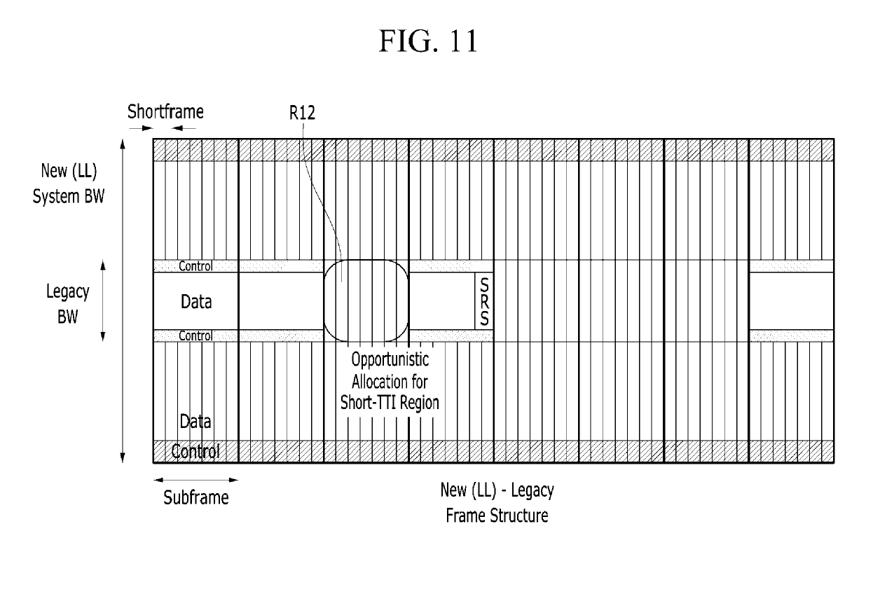

FIG. 10 is an illustrative view showing a downlink frame structure in which a legacy region is varied according to an exemplary embodiment of the present invention, and FIG. 11 is an illustrative view showing an uplink frame structure in which a legacy region is varied according to an exemplary embodiment of the present invention.

In a DL frame, as shown in FIG. 10, a low latency region and a legacy region are included, and some S11 of subframes of the legacy region are set so as not to be used by the legacy terminals. The subframe as described above is called a “legacy non-allocated subframe”. The legacy non-allocated subframe of the legacy region may be used for terminals requesting the low latency service.

Meanwhile, in a UL frame, there is no method of allowing some of subframes of the legacy region not to be explicitly used. Therefore, as shown in FIG. 11, a subframe R12 in which data transmission or control signal transmission for the legacy terminals in the legacy region is not generated may be opportunistically used for the low latency system.

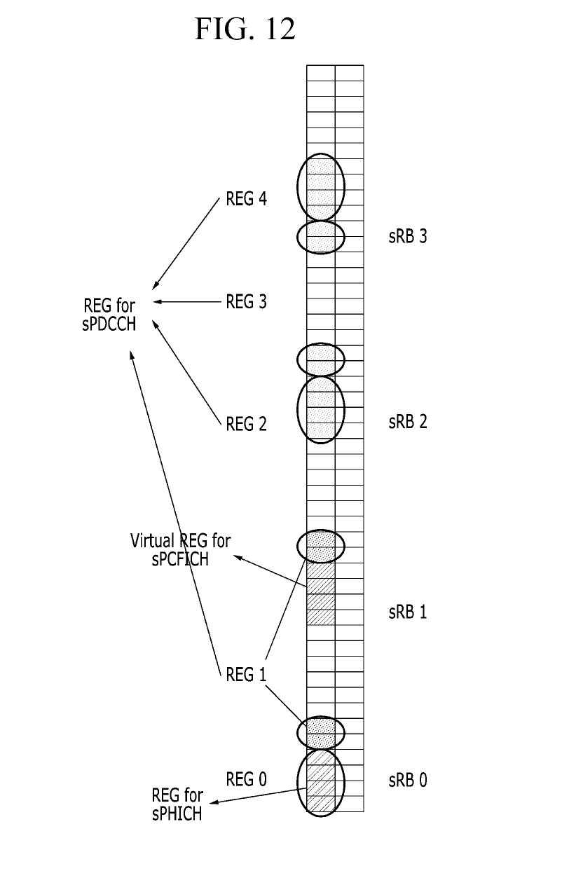

FIG. 12 is an illustrative view showing a configuration of a control region of a low latency system according to an exemplary embodiment of the present invention.

The control region of the low latency system band is present per TTI (short-TTI), and is configured of some of resource elements (RE) configuring the TTI. The control region is not used for transmitting higher layer data, but is used for transferring resource allocation information, HARQ feedback information, control channel configuration information, and the like.

Sizes of the control regions in the low latency system band may be fixed to a predetermined size or be varied to different sizes per TTI. In order to configure the control region having the fixed or varied size, it may be indicated that the size of the control region is fixed or varied through the primary broadcasting information. In the case in which the size of the control region is varied, a channel (short physical control format indicator channel (sPCFICH) for indicating the size of the control region may be configured. In FIG. 11, “REG” indicates a “resource element group”.

Indication information for indicating that the size of the control region is fixed or varied through the primary broadcasting information may be configured as shown in the following Table 1.

TABLE 1

| Field | Size | Description |
|---|---|---|
| sPCFICH | 1 bit | 0: Fixed Control Region Size (sPCFICH may not be |
| Information | | configured) |
| | | 1: Dynamic Control Region Size (sPCFICH may not |
| | | be configured) |

In order to decrease an overhead of sPCFICH, which is a channel for indicating the size of the control region, a period in which the size of the control region is varied may be changed. In the case in which the period in which the size of the control region is varied is larger than one TTI size, sPCFICH is configured once per corresponding period. In this case, information on the period in which the size of the control region is varied may be included in the primary broadcasting information.

In this case, the indication information for indicating that the size of the control region is fixed or varied through the primary broadcasting information may include the information on the period in which the size of the control region is varied, and may be configured as shown in the following Table 2.

TABLE 2

| Field | Size | Description |
|---|---|---|
| sPCFICH | 2 bit | 0: Fixed Control Region Size (sPCFICH may not be |
| Information | | configured) |
| | | 1: Dynamic Control Region Size, Period Infor- |
| | | mation (changes per Subframe) (sPCFICH may be |
| | | configured in a first TTI per subframe) |
| | | 2: Dynamic Control Region Size, Period Infor- |
| | | mation (changes per TTI) (sPCFICH may be |
| | | configured per TTI) |

Two bits of indication information, that is, control format indicator (CFI) information may be transmitted as shown in, for example, the above Table 2 through sPCFICH for indicating the size of the control region. The terminal figures out the size of the control region using the two bits of CFI information to configure channels of the control region. The control region depending on the CFI information may be configured as follows.

TABLE 3

| CFI | |
|---|---|
| Value | Description |
| 0 | 4 REs are allocated to control region per sRB |
| 1 | 6 REs are allocated to control region per sRB |
| 2 | 8 REs are allocated to control region per sRB |
| 3 | All REs in first symbols are allocated to control region per sRB |

In the above Table 3, a unit in which the size of the control region is varied is the number of REs. However, in addition to the number of REs, a ratio (for example, 20%, 30%, or 40%) of the control region among all REs, a maximum size (for example, 1 symbol) of a resource occupied by the control region, or the like, may be designated as the unit. It is assumed that REs configuring the control region do not include REs for a reference signal. However, in some cases, the control region may also be defined as a region including the reference signal.

In each RB, the control regions may be configured from the lowest subcarrier index among the subcarrier indices of each RB. Alternatively, the control regions may be configured form a subcarrier index having a predetermined offset. In the latter case, in order to allow positions of the control regions in each cell not to be the same as each other in consideration of a case for inter-cell interference randomization, the control regions are configured from the subcarrier index having the offset. In order configure different control regions in each cell, different offsets may be set as follows.

k_{offset}=N^{cell}_{ID} mod N^{RB}_{SC} [Equation 3]

Here, N^{cell}_{ID} indicates a cell identifier (ID), and N^{RB}_{SC} indicates the number of subcarriers per RB.

On the basis of the offsets set as described above, the control region of each RB may be configured as follows.

k0(k)=k*N^{RB}_{SC} [Equation 4]

Here, k0 indicates a starting RE index among RB indices K. The REs may be indexed like (k,l). k=k0+(k_{offset}+n mod N^{RB}_{SC}), n=0, 1, . . . , N—1 and l=0. Here, N indicates the number of REs between the control regions.

Even in the case in which the size of the control region is varied, a position to which the channel (sPCFICH) indicating the size of the control region is mapped needs to be irrelevant to the varied size of the control region. For this purpose, as a method of mapping a position of the channel (sPCFICH) indicating the size of the control region, for example, indices of the RBs to which the sPCFICH channel is allocated may be determined, and the sPCFICH may be mapped to first four REs in the control region of the determined RBs.

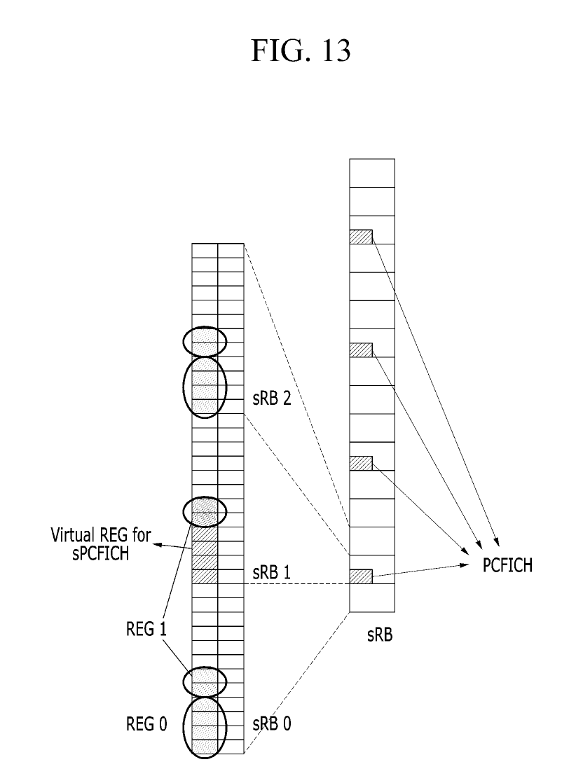

FIG. 13 is an illustrative view showing mapping of a position of a channel (sPCFICH) indicating a size of a control region according to an exemplary embodiment of the present invention.

For example, as shown in FIG. 13, a RB sRB1 to which the channel is to be mapped may be selected, and the sPCFICH channel may be mapped to a virtual resource element group (REG) including first four REs in the control region of the selected RB.

A method of selecting the RB may be represented by the following Equation.

$$\overline{{n}_{i}} = \{ \begin{matrix}( ⌊ {N}_{ID}^{cell} ⌋ + {m}^{′} ) mod {n}_{0} & i = 0 \\ ( ⌊ {N}_{ID}^{cell} ⌋ + {m}^{′} + ⌊ {n}_{0} / 3 ⌋ ) mod {n}_{0} & i = 1 \\ ( ⌊ {N}_{ID}^{cell} ⌋ + {m}^{′} + ⌊ 2 {n}_{0} / 3 ⌋ ) mod {n}_{0} & i = 2\end{matrix} \qquad [ Equation 6 ]$$

The remaining channels except for the sPCFICH channel indicating the size of the control region may be configured in the remaining REs that are not allocated to the sPCFICH among the REs of the control region. For example, after the remaining REs of the control region are bound in an REG unit including four REs, a HARQ indication channel (sPHICH, short Physical Harq Indicator Channel) and a short physical downlink control channel (sPDCCH) may be configured in the REG unit.

The sPHICH may be configured, for example, as follows.

$${z}^{( p )} ( 0 ) is mapped to the 1 st virtual REG of the resource block represented by k = \overline{k} \\ {z}^{( p )} ( 1 ) is mapped to the 1 st virtual REG of the resource block represented by k = \overline{k} + ⌊ {N}_{sRB}^{DL} / 4 ⌋ \\ {z}^{( p )} ( 2 ) is mapped to the 1 st virtual REG of the resource block represented by k = \overline{k} + ⌊ 2 {N}_{sRB}^{DL} / 4 ⌋ \\ {z}^{( p )} ( 3 ) is mapped to the 1 st virtual REG of the resource block represented by k = \overline{k} + ⌊ 3 {N}_{sRB}^{DL} / 4 ⌋ \\ \overline{k} = ( {N}_{ID}^{cell} mod {N}_{sRB}^{DL} ) \\ Note that k is index of sRB , k = 0 , 1 , ⋯ , {N}_{sRB}^{DL} \qquad [ Equation 5 ]$$

Here, n̅ᵢ indicates an REG index to which the sPHICH is allocated, m′ indicates a sPHICH group index, n₀ indicates a total number of REGs in a subslot.

The sPDCCH channel for transmitting resource allocation information may be configured in an REG in which the SPICH is not configured among the REGs. The configured REG may configure a control channel element (CCE) in a unit of nine REGs to thereby be used as the sPDCCH for transmitting control information.

On the basis of this frame structure, a coexisting system in which the low latency system and the legacy system coexist with each other is provided in an exemplary embodiment of the present invention.

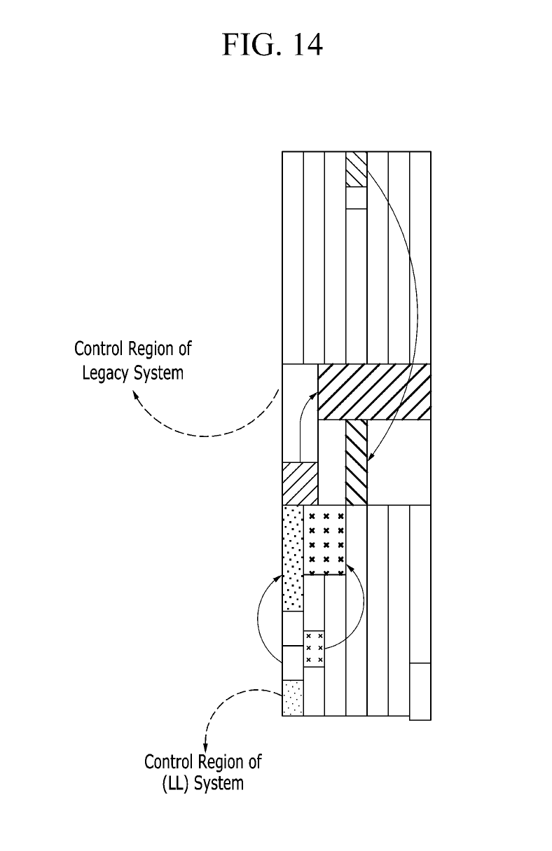

FIG. 14 is a view showing a control region and resource allocation in a system according to an exemplary embodiment of the present invention.

In the coexisting system in which the low latency system and the legacy system coexist with each other according to an exemplary embodiment of the present invention, as shown in FIG. 14, resource allocation of a legacy region for legacy terminals is performed in a control region (for example, a physical downlink control channel (PDCCH)) of the legacy system. In addition, resource allocation of terminals of the low latency system is performed in a control region of the low latency system.

Additionally, for the purpose of flexibility of the resource allocation, resource allocation for data regions (for example, a physical downlink shared channel (PDSCH) and a legacy non-allocated subframe) that are not allocated for the legacy terminals in a band of the legacy region may be performed in the control region of the low latency system.

Meanwhile, in an exemplary embodiment of the present invention, synchronization and system information (for example, a master information block (MIB)) may be transferred to terminals that intend to access the low latency system as well as the legacy system through a synchronization signal and a broadcasting physical channel.

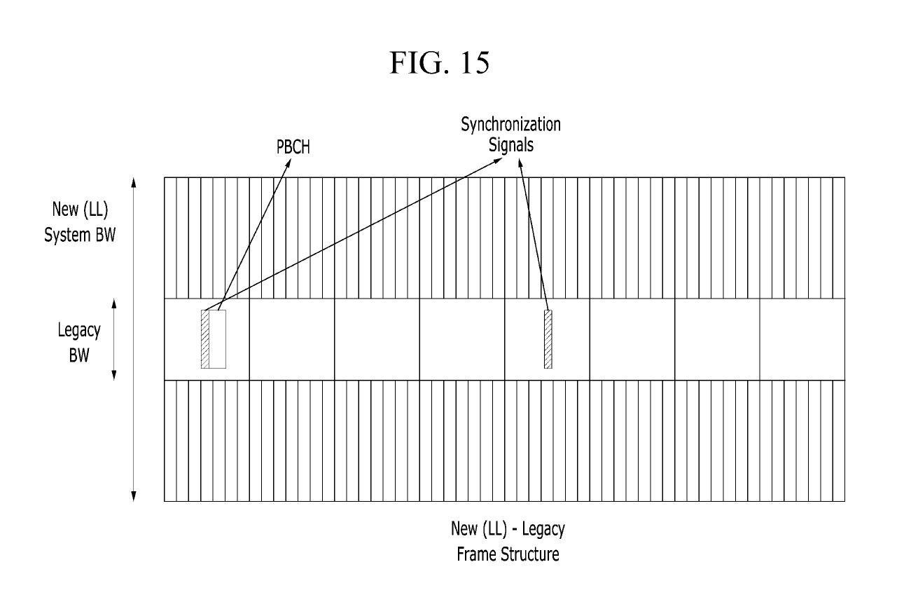

FIG. 15 is an illustrative view showing synchronization signals and physical channel transmission and in a system according to an exemplary embodiment of the present invention.

In an exemplary embodiment of the present invention, the synchronization and system information may be transferred to the terminals that intend to access the low latency system as well as the legacy system through a synchronization signal and a broadcasting physical channel PBCH present in the legacy region, which is a frequency band for the legacy system, as shown in FIG. 15.

In addition, additional information (for example, a total system band, or the like) for the terminals for accessing the low latency system may be added to the MIB transmitted through the broadcasting physical channel present in the legacy region and be then transmitted or may be transmitted through a method of adding a secondary information block (SIB) for the low latency system.

Meanwhile, in the coexisting system in which the low latency system and the legacy system coexist with each other according to an exemplary embodiment of the present invention, a hybrid automatic repeat request (HARQ) procedure follows a HARQ procedure defined in the legacy system.

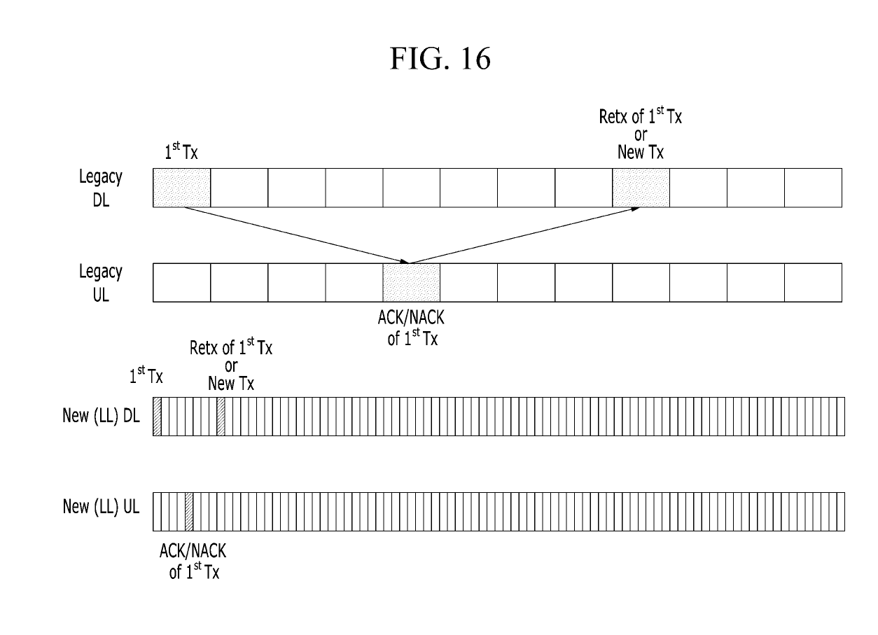

FIG. 16 is an illustrative view showing transmission of a HARQ retransmission time in a system according to an exemplary embodiment of the present invention.

A HARQ procedure for HARQ feedback and retransmission of a transport block (TB) performed in the band of the legacy system follows the HARQ procedure defined in the legacy system.

Likewise, a HARQ procedure of a transport block performed in the frequency band of the low latency system follows a HARQ procedure defined in the low latency system. In addition, a HARQ procedure of a transport block in the frequency band of the legacy system allocated through the control region of the low latency system also follows the HARQ procedure defined in the low latency system.

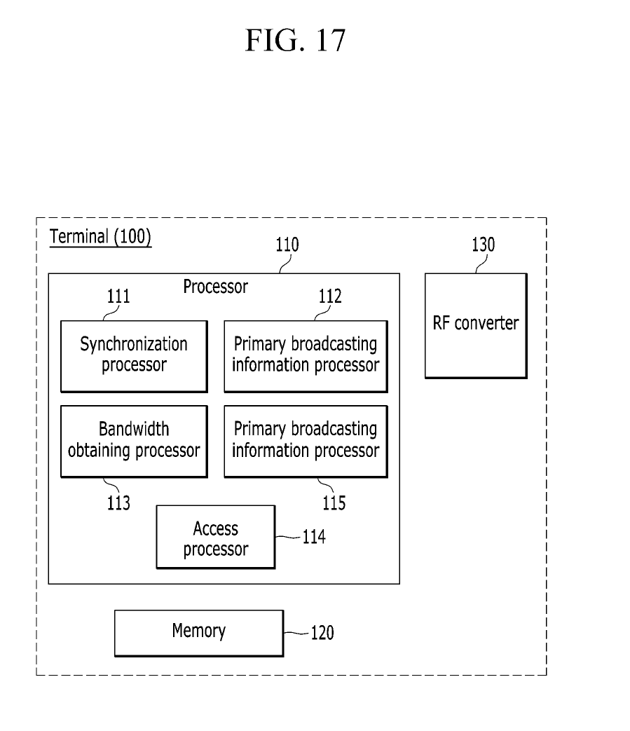

FIG. 17 is a block diagram of a terminal for a low latency system access and operation according to an exemplary embodiment of the present invention.

As shown in FIG. 17, the terminal 100 according to an exemplary embodiment of the present invention includes a processor 110, a memory 120, and a radio frequency (RF) converter 130. The processor 110 may be configured to implement the methods described with reference to FIGS. 5 to 16.

For this purpose, the processor 110 includes a synchronization processor 111, a primary broadcasting information processor 112, a bandwidth obtaining processor 113, an access processor 114, and a secondary broadcasting information processor 115.

The synchronization processor 111 receives a legacy synchronization signal or a low latency system synchronization signal to perform synchronization.

The primary broadcasting information processor 112 receives and processes the primary broadcasting information transmitted through the broadcasting physical channel of the legacy system band.

The bandwidth obtaining processor 113 calculates the low latency system bandwidth on the basis of the legacy system bandwidth and the total system bandwidth included in the primary broadcasting information. In addition, the bandwidth obtaining processor 113 adjusts the total system bandwidth on the basis of the calculated low latency system bandwidth and the legacy system bandwidth.

The access processor 114 performs an access to the low latency system on the basis of the low latency system bandwidth provided from the bandwidth obtaining processor 113. That is, the access processor 114 receives system information through the control and data regions of the low latency system band, and performs an access on the basis of the received system information.

The secondary broadcasting information processor 115 receives the secondary broadcasting information transmitted through the control and data regions of the legacy system band after the terminal accesses the low latency system, and obtains low latency system setting information from the secondary broadcasting information.

The memory 120 is connected to the processor 110, and stores various information related to an operation of the processor 110 therein. The RF converter 130 is connected to the processor 110, and transmits or receives wireless signals.

Meanwhile, in another exemplary embodiment of the present invention, some of the resources in the band of the legacy system are allocated to a short-TTI structure for the low latency service to support terminals requesting a short-TTI operation and low latency services.

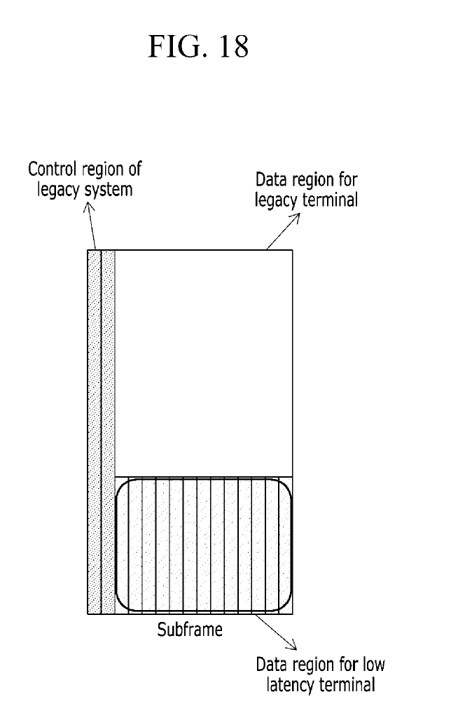

FIG. 18 is a view showing a frame structure in a low latency system according to another exemplary embodiment of the present invention.

In another exemplary embodiment of the present invention, as shown in FIG. 18, a frequency band for the legacy system, that is, a legacy system band is configured in a total system band, and some of the resources are used for a short-TTI structure for the low latency service. That is, some of the resources are used as a short-TTI region (hereinafter, referred to as a low latency region for convenience of explanation) for the low latency system. Therefore, some of the resources in the total system band may be allocated to the data region for the legacy terminals supported by the legacy system, and some of the resources may be allocated to the data region for terminals (referred to as low latency terminals for convenience of explanation) requesting the low latency service.

A size of a physical downlink control channel (PDCCH) region, which is a control region for allocating the data region for the legacy terminals may be configured of one OFDM symbol to three OFDM symbols, and may be configured depending on a configuration method in the legacy system. In order to ensure time continuity of a section for the low latency service as much as possible, a PDCCH region configured of one OFDM symbol, which is a minimum length, may be used.

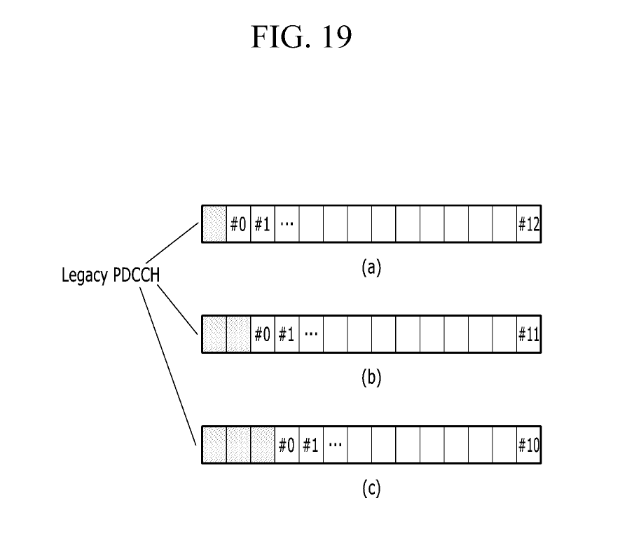

FIG. 19 is a view showing examples of a low latency region and a PDCCH region according to another exemplary embodiment of the present invention.

In a subframe configured of fourteen symbols of the legacy system band, as illustrated in FIG. 19, a short-TTI of one symbol for the low latency region may be configured. In this case, PDCCH regions of the legacy system may be configured, one symbol, two symbols, and three symbols, respectively. In detail, the PDCCH region of the legacy system may be configured of one symbol (FIG. 19A), the PDCCH region of the legacy system may be configured of two symbols (FIG. 19B), or the PDCCH region of the legacy system may be configured of three symbols (FIG. 19C).

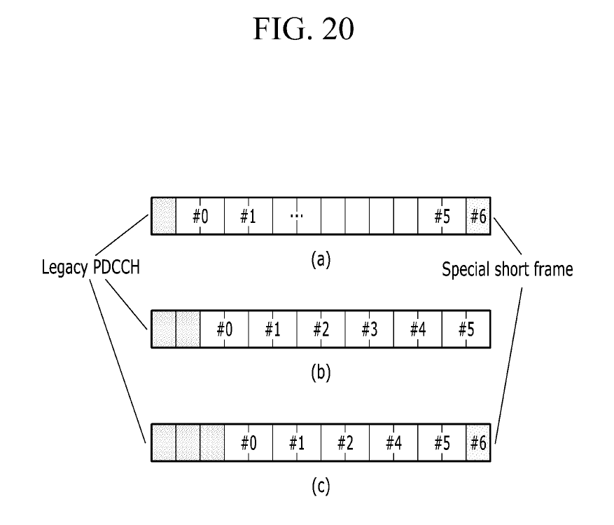

FIG. 20 is a view showing another examples of a low latency region and a PDCCH region according to another exemplary embodiment of the present invention.

The PDCCH regions of the legacy system may be configured of one symbol, two symbols, and three symbols, respectively, as described above, and the low latency region may be configured of a short-TTI of two symbols. In this case, the short-TTI of the two symbols may not be configured so as to accord with a subframe configured of fourteen symbols. In detail, as shown in FIG. 20, in the case in which the PDCCH region of the legacy system is configured of one symbol ((a) of FIG. 20) or is configured of three symbols ((c) of FIG. 20), there is one extra symbol. This extra symbol may be called a special short frame.

The special short frame may be utilized for a specific purpose such as data transmission, control signaling, or the like. The special short frame is a final short frame, and the number of symbols included in the special short frame is less than that of symbols included in other short frames. Therefore, in the case in which the special short frame is used for data transmission, the data needs to be transmitted using resources less than those of a short frame. Therefore, the special short frame may be used for a terminal having a good channel environment or data transmission having a small size. Furthermore, the special short frame may be used for transmission of hybrid automatic repeat request (HARQ) feedback, scheduling information, channel state information, a sounding reference signal for the channel state information, and the like.

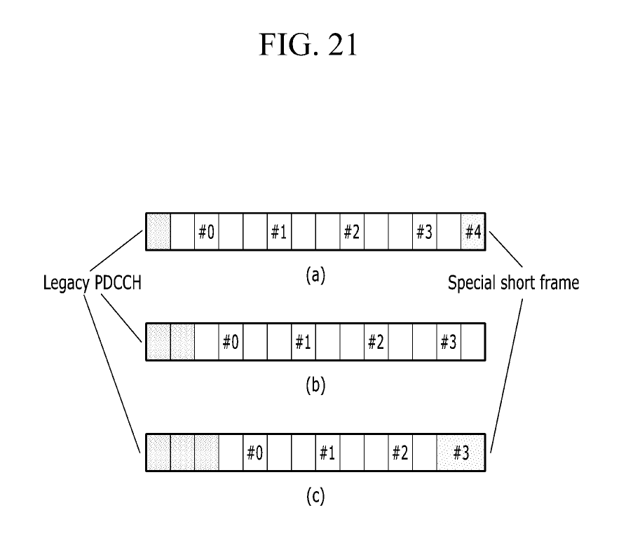

FIG. 21 is a view showing another example of a low latency region and a PDCCH region according to another exemplary embodiment of the present invention.

The PDCCH regions of the legacy system may be configured of one symbol, two symbols, and three symbols, respectively, as described above, and the low latency region may be configured of a short-TTI of three symbols. Also in this case, the short-TTI of the three symbols may not be configured so as to accord with a subframe configured of fourteen symbols. In detail, as shown in FIG. 21, in the case in which the PDCCH region of the legacy system is configured of one symbol ((a) of FIG. 21) or is configured of three symbols ((c) of FIG. 21), there is a special short frame, which is one extra symbol or two extra symbols.

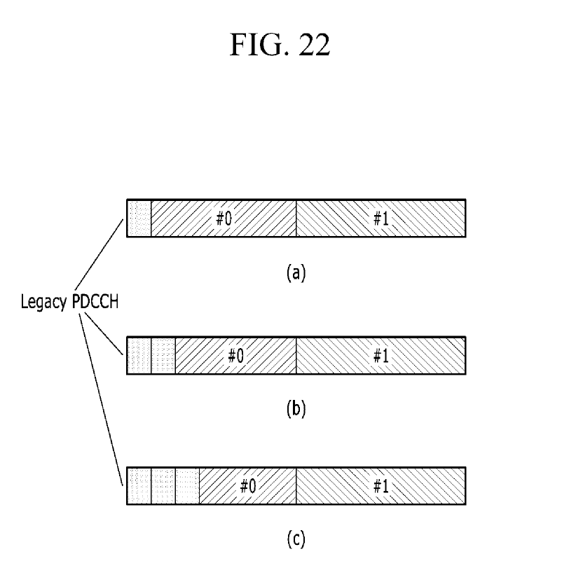

FIG. 22 is a view showing another example of a low latency region and a PDCCH region according to another exemplary embodiment of the present invention.

The PDCCH regions of the legacy system may be configured of one symbol, two symbols, and three symbols, respectively, as described above, and the low latency region may be configured of a short-TTI of a slot, that is, seven symbols ((a) of FIG. 22). In this case, in order to allow boundaries of slots of the legacy system to coincide with each other, a first short frame may be configured of symbols less than seven symbols ((b) and (c) of FIG. 22). In detail, as shown in (b) of FIG. 22, when the PDCCH region of the legacy system is configured of two symbols, the first short frame may be configured of five symbols to perform the same slot unit resource configuration as that of the legacy system.

Short-TTI regions for the low latency terminals according to an exemplary embodiment of the present invention may be allocated in a subframe unit of the legacy system, and may be configured in some frequency region of a total frequency. Information on the short-TTI regions may be provided through downlink control information (DCI) transmitted through the PDCCH.

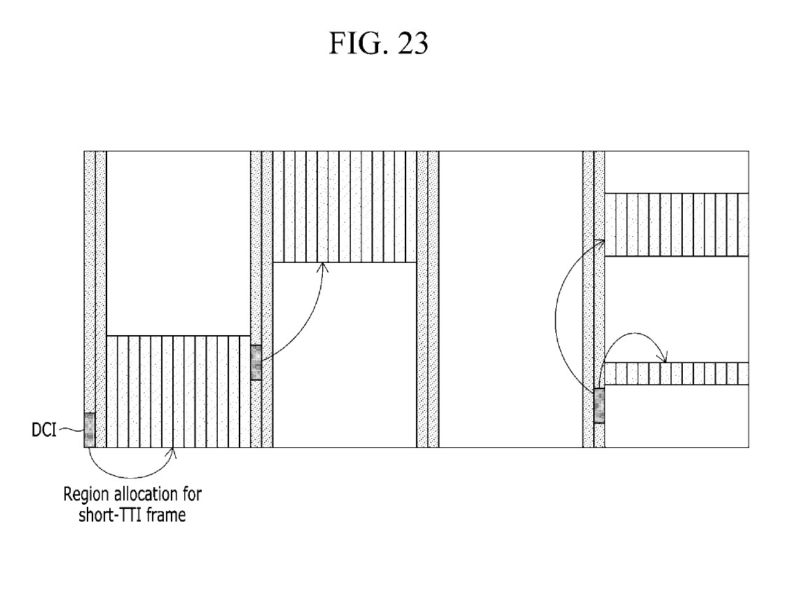

FIG. 23 is a view showing an example of allocating a short-TTI region for a low latency system on the basis of a legacy system band in another exemplary embodiment of the present invention.

The low latency regions for the low latency service may be positioned in various frequency resources of the legacy system bands, as shown in FIG. 23. Short-TTI resources configuring the low latency region may be allocated in a subframe unit of the legacy system band, information on positions of the allocated short-TTI resources may be provided through DCI transmitted through the PDCCH, which is the control region. A base station may determine optimal positions of the resources in consideration of channel information of the terminals performing an access through these short-TTIs.

In addition, in an exemplary embodiment of the present invention, the positions of the short-TTI resources may be set using a method of transmitting information on the allocated resources of the low latency region through higher layer signaling (for example, radio resource control (RRC) signaling, or the like), in addition to a method of transmitting the information on the allocated resources of the low latency region through the PDCCH. In this case, there may be a constraint in dynamically changing the short-TTI resources in a short time unit.

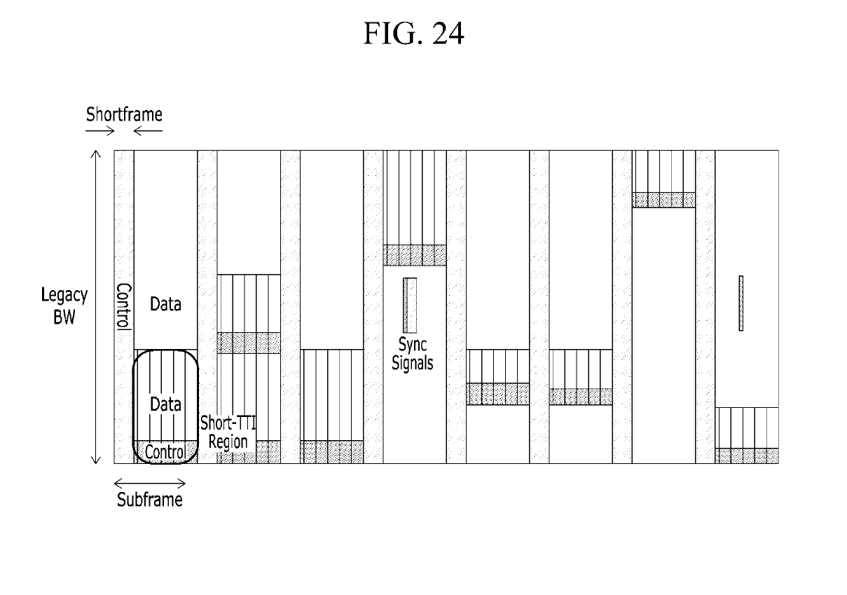

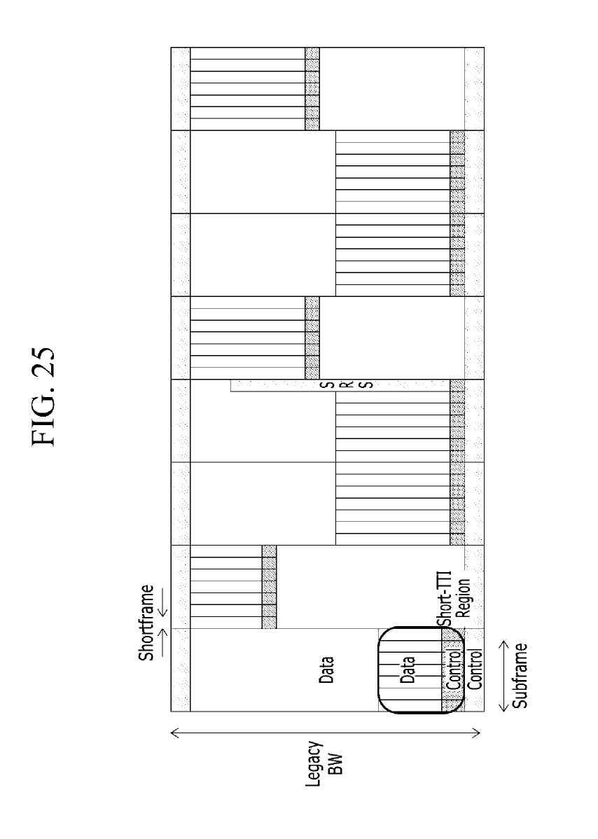

FIG. 24 is an illustrative view showing a downlink frame structure according to another exemplary embodiment of the present invention, and FIG. 25 is an illustrative view showing an uplink frame structure according to another exemplary embodiment of the present invention.

In a downlink (DL) frame, as shown in FIG. 24, some of the resources in a frame based on the legacy system band are used as the low latency region for the low latency system to allocate the short-TTI frames. In addition, information on the allocated low latency region, that is, the short-TTI region may be transmitted through the PDCCH region or be transmitted through higher layer signaling.

In addition, an uplink (UL) frame, as illustrated in FIG. 25, some of the resources of the legacy system band are used as the low latency region, and data transmission, or the like, may be performed.

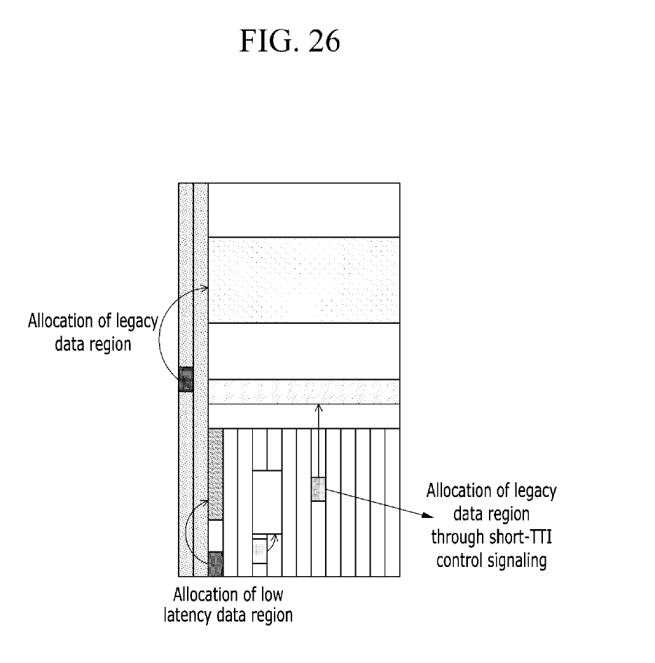

As described above, in a frame structure in which the legacy system band and the low latency region coexist with each other, resource allocation for data transmission may be performed as shown in FIG. 26.

FIG. 26 is an illustrative view showing resource allocation for data transmission in a frame structure according to another exemplary embodiment of the present invention.

Some of the resources of the legacy system band are used as the low latency region, and allocation of the legacy data region for the legacy terminals may be performed through the control region of the legacy system. In addition, as shown in FIG. 26, short-TTI frames of the low latency region are allocated to some of the resources, and some of the low latency region is allocated as a data region for data transmission of the low latency terminals. In addition, information on the data region allocated for the low latency terminals may be transmitted through control signaling of the low latency region. For this purpose, a control channel for which the control signaling in the low latency region is transmitted may be configured. Information (or may be called configuration information on the control region) for configuring the control channel in the low latency region may be included in control information (or may be called configuration information of the low latency region, for example, DCI) for allocating the low latency region or be included in higher layer signaling.

In addition, terminals that may receive the control signaling of the low latency region may also perform data transmission through a region of the legacy system. In this case, the data region of the legacy system may be allocated through the control signaling of the low latency region. That is, as shown in FIG. 26, information on the data region allocated for the legacy terminals may be transmitted through short-TTI control signaling.

To the contrary, an allocation operation of the data region of the low latency region through the control region of the legacy system is possible. In this case, a resource allocation message transmitted in the control region in the legacy system includes a TTI index indicating a sequence of the corresponding frame as well as positions of frequency resources in the low latency region. In the case in which resource allocation for the data region is possible in only a first TTI of TTIs of the low latency region through the control region of the legacy system, the resource allocation message may not include the TTI index.

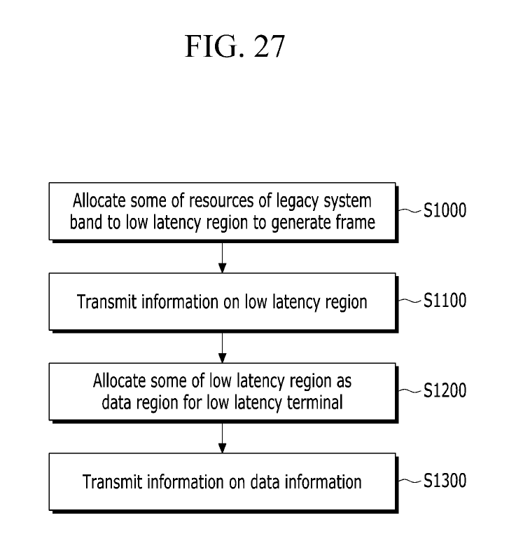

FIG. 27 is a flow chart of a method of transmitting a frame according to another exemplary embodiment of the present invention.

A base station generates a frame for the low latency service in a mobile communication system supporting a new service such as the low latency service. In detail, as shown in FIG. 27, some of the resources in the legacy system band, which is a frequency band for supporting the legacy system, are allocated to a region for supporting the low latency service, that is, the low latency region to generate the frame (S1000). The low latency region is configured in a short-TTI structure. Information on the low latency region may be transmitted through the control region of the legacy system band or be transmitted through the higher layer signaling (S1100).

As described above, the frame in which the legacy system band and the low latency region coexist with each other is generated, and some of the low latency region is allocated as the data region for data transmission of the low latency terminals (S1200). Then, the information on the data region allocated for the low latency terminals may be transmitted through the control signaling of the low latency region or the control signaling of the legacy region (S1300).

Meanwhile, in the coexisting system in which the low latency system and the legacy system coexist with each other according to an exemplary embodiment of the present invention, a HARQ procedure follows a HARQ procedure defined in the legacy system.

A HARQ procedure for HARQ feedback and retransmission of a transport block (TB) performed in the band of the legacy system follows the HARQ procedure defined in the legacy system.

Likewise, a HARQ procedure of a transport block performed in the low latency region, which is the short-TTI region, follows a HARQ procedure in the low latency region. In addition, a HARQ procedure of the data transmission in the data region of the legacy system follows the HARQ procedure defined in the legacy system.

In the case in which resources for performing the HARQ procedure in the low latency region are insufficient or in the case in which a channel for HARQ feedback in the low latency region is not present, feedback using a HARQ feedback channel of the legacy region may be performed. Furthermore, also in the case of a service that does not require rapid retransmission in the low latency region, a HARQ operation may be performed through the feedback using the HARQ feedback channel of the legacy region.

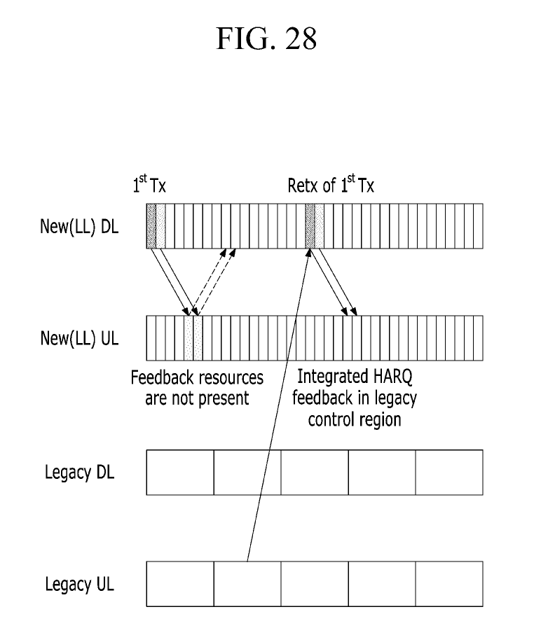

FIG. 28 is a view showing HARQ feedback in a low latency region according to another exemplary embodiment of the present invention.

Data transmission of a predetermined service is performed through the data region of the low latency region, and HARQ of the data transmission is performed depending on a HARQ procedure in the low latency region. Here, in the case in which resources for performing the HARQ procedure in the low latency region are not present, HARQ feedback of a data transport block may be performed through a control region or a data region of an uplink frame (Legacy UL) of the legacy system, as shown in FIG. 28. This integrated feedback may be a service that does not require rapid retransmission, for example, a voice of Internet protocol (VoIP) service, a file transmission service, or the like.

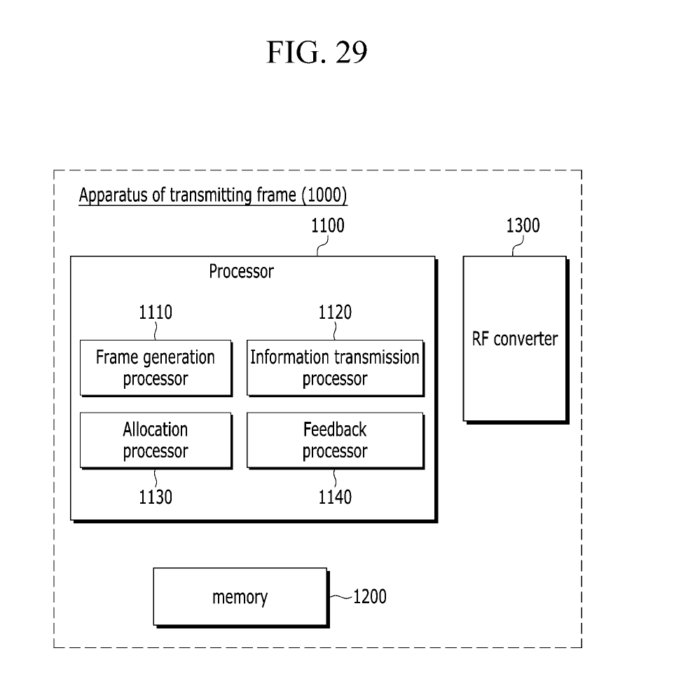

FIG. 29 is a block diagram of an apparatus of transmitting a frame according to another exemplary embodiment of the present invention.

As shown in FIG. 29, the apparatus 1000 of transmitting a frame according to another exemplary embodiment of the present invention includes a processor 1100, a memory 1200, and a radio frequency (RF) converter 1300. The processor 1100 may be configured to implement the methods described with reference to FIGS. 18 to 29.

For this purpose, the processor 1100 includes a frame generation processor unit 1110 and an information transmission processor 1120, and further includes an allocation processor 1130 and a feedback processor 1140.

The frame generation processor 1110 generates a frame for the low latency service, and allows some of the resources in the legacy system band to be allocated to the low latency region configured in the short-TTI structure while supporting the low latency service, thereby generating the frame.

The information transmission processor 1120 transmits information on the low latency region. The information on the low latency region may be transmitted through the control region of the legacy system band or be transmitted through the higher layer signaling.

The allocation processor 1130 allocates some of the low latency region as the data region for data transmission of the low latency terminals, and transmits information on the data region allocated for the low latency terminals through the control signaling of the low latency region.

The feedback processor 1140 performs a HARQ procedure of the data transmission performed in the low latency region. In the case in which resources for performing the HARQ procedure in the low latency region are insufficient, HARQ feedback may be performed through the control region or the data region of the legacy system.

The memory 1200 is connected to the processor 1100, and stores various information related to an operation of the processor 1100 therein. The RF converter 1300 is connected to the processor 1100, and transmits or receives wireless signals.

According to an exemplary embodiment of the present invention, through the frame having the structure in which the low latency system and the legacy system coexist with each other, it is possible to support both of apparatuses that may access only the legacy system and apparatuses for the low latency service when one frequency band is available.

In addition, since the low latency system and the legacy system may be supported at the same time, it is possible to efficiently support the legacy system without having an influence on a latency time, which is a core of the low latency service.

Further, since resource regions of the low latency system and the legacy system may be dynamically configured in a subframe unit as well as a frequency band, optimal resource distribution in which loads of the respective systems are reflected may be performed.

Further, the mobile communication system supporting the low latency service may configure a frame having a short-transmission time interval (TTI) for supporting the low latency service. Due to the structure of the short-TTI frame, one cell may support the low latency service as well as the service in the legacy system when one frequency band is available.

Furthermore, since the short-TTI region may be allocated using a resource allocation function of the legacy system, resource allocation in which signal to interference noise ratios (SINRs) of low latency terminals using relatively small numbers of OFDM symbols, and the like, are considered may be performed, and quality of the low latency service may be improved.

The exemplary embodiments of the present invention described above are not implemented through only the apparatus and/or the method described above, but may also be implemented through programs executing functions corresponding to configurations of the exemplary embodiments of the present invention, a recording medium in which the programs are recorded, and the like. In addition, these implementations may be easily made by those skilled in the art to which the present invention pertains from the exemplary embodiments described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting a frame supporting a legacy system in a mobile communication system, comprising:
generating a frame including a first frequency band for supporting the mobile communication system and a second frequency band for supporting the legacy system and having a total frequency band larger than the second frequency band; and
transmitting primary broadcasting information through a broadcasting physical channel of the second frequency band.

2. The method of transmitting a frame of claim 1, wherein:
the primary broadcasting information includes a legacy system bandwidth and a total frequency bandwidth, and
the method further comprising:
transmitting secondary broadcasting information through a data region of the second frequency band,
wherein the secondary broadcasting information includes band configuration information of the mobile communication system.

3. The method of transmitting a frame of claim 1, further comprising:
setting some of subframes of the second frequency band so as not to be used by a terminal accessing the legacy system and setting some of the subframes of the second frequency band so as to be used for a terminal requesting low latency services of the mobile communication system,
wherein the setting includes:
constraining an operation of the terminal accessing the legacy system in some of the subframes through a multimedia broadcast single frequency network (MBSFN) subframe configuration or an almost blank subframe (ABS) configuration in a downlink frame of the legacy system of the second frequency band; and
constraining uplink transmission scheduling of the terminal accessing the legacy system in some of the subframes in an uplink frame of the legacy system of the second frequency band to use resources for a service of a terminal of the mobile communication system.

4. The method of transmitting a frame of claim 1, wherein:
the frame of the mobile communication system is configured in a transmission time interval (TTI) structure shorter than that of a frame of the legacy system, some of radio resources configuring each TTI of the first frequency band are used as control regions, and the control regions have a predetermined size or have sizes different from each other per TTI.

5. The method of transmitting a frame of claim 4, wherein:
the primary broadcasting information includes indication information for indicating that a size of the control region is fixed or varied, and the indication information on the size of the control region is transmitted through a short physical control format indicator channel (sPCFICH) in the case in which the size of the control region is varied, and
when a period in which the size of the control region is varied is larger than one TTI size, the sPCFICH is configured once per corresponding period, and the primary broadcasting information includes information on the period in which the size of the control region is varied.

6. The method of transmitting a frame of claim 4, wherein:
the size of the control region is determined by control format indicator (CFI) information, and indicates one of the number of radio resources configuring the control region, a ratio of radio resources occupied by the control region to total radio resources, and a maximum size of the radio resources occupied by the control region.

7. The method of transmitting a frame of claim 5, wherein:
radio resources to which the sPCFICH is to be mapped are selected, the sPCFICH is allocated to a plurality of radio resources from a first radio sources among the selected radio resources, a channel other than the sPCFICH is allocated to the other of the selected radio resources, and the channel other than the sPCFICH includes one of a hybrid automatic repeat request (HARQ) indication channel (short physical Harq indicator channel (sPHICH)) and a short physical downlink control channel (sPDCCH).

8. A method of searching a cell by a terminal in a mobile communication system supporting a legacy system, comprising:
the terminal receiving primary broadcasting information through a broadcasting physical channel of a second frequency band in a structure in which a frame includes a first frequency band for supporting the mobile communication system and the second frequency band for supporting the legacy system;
the terminal receiving system information through control and data regions of the first frequency band on the basis of the primary broadcasting information; and
performing an access to the mobile communication system on the basis of the received system information.

9. The method of searching a cell of claim 8, wherein:
the primary broadcasting information includes a legacy system bandwidth and a total frequency bandwidth, and
the method further comprising:
after the receiving of the primary broadcasting information,
calculating a bandwidth of the mobile communication system on the basis of the legacy system bandwidth and a total system bandwidth; and
adjusting the total system bandwidth on the basis of the calculated bandwidth of the mobile communication system and the legacy system bandwidth.

10. The method of searching a cell of claim 9, wherein:
in the case in which both of the legacy system bandwidth and the total system bandwidth are odd numbers or are even numbers, the total system bandwidth included in the primary broadcasting information and the adjusted total system bandwidth have the same value, and
in the case in which one of the legacy system bandwidth and the total system bandwidth is an odd number or the other thereof is an even number, the adjusted total system bandwidth has a value smaller than that of the total system bandwidth included in the primary broadcasting information by 1.

11. The method of searching a cell of claim 9, further comprising:
before the receiving of the primary broadcasting information, the terminal receiving a legacy synchronization signal or a mobile communication system synchronization signal to perform synchronization; and
after the performing of the access, receiving secondary broadcasting information through control and data regions of the second frequency band, the second broadcasting information including setting information of the mobile communication system.

12. A terminal in a mobile communication system supporting a legacy system, comprising:
a radio frequency (RF) converter transmitting and receiving signals through an antenna; and
a processor connected to the RF converter and performing a cell search,
wherein the processor includes:
a primary broadcasting information processor receiving and processing primary broadcasting information through a broadcasting physical channel of a second frequency band in a structure in which a frame includes a first frequency band for supporting the mobile communication system and the second frequency band for supporting the legacy system; and
an access processor receiving system information through control and data regions of the first frequency band on the basis of the primary broadcasting information and performing an access on the basis of the received system information.

13. The terminal of claim 12, wherein:
the primary broadcasting information includes a legacy system bandwidth and a total frequency bandwidth, and
the processor further includes:
a bandwidth processing unit calculating a bandwidth of the mobile communication system on the basis of the legacy system bandwidth and the total frequency bandwidth and adjusting a total system bandwidth on the basis of the calculated bandwidth of the mobile communication system and the legacy system bandwidth.

14. The terminal of claim 12, wherein: the processor further includes:
a synchronization processor receiving a legacy synchronization signal or a mobile communication system synchronization signal to perform synchronization, before the primary broadcasting information is received; and
a secondary broadcasting information processor receiving and processing secondary broadcasting information through control and data regions of the second frequency band, the second broadcasting information including setting information of the mobile communication system.

15. A method of transmitting a frame in a mobile communication system supporting low latency services, comprising:
generating a frame in which some of resources of a legacy system band, which is a frequency band for supporting a legacy system, are allocated to a low latency region for the low latency service; and
transmitting information on the low latency region.

16. The method of transmitting a frame of claim 15, wherein:
the low latency region is configured in a short-transmission time interval (TTI) structure, and is allocated in a subframe unit of the legacy system band, and
a final short frame of short frames configuring the low latency region having the short-TTI structure is configured of symbols less than those of other short frames or
a first short frame of the short frames configuring the low latency region having the short-TTI structure is configured of symbols less than those of other short frames.

17. The method of transmitting a frame of claim 15, wherein:
the transmitting of the information includes at least one of:
transmitting the information on the low latency region through a control region of the legacy system band; and
transmitting the information on the low latency region through higher layer signaling.

18. The method of transmitting a frame of claim 15, further comprising:
allocating some of the low latency region as a control region for control information transmission of a low latency terminal; and
allowing configuration information on the control region of the low latency region to be included in configuration information of the low latency region.

19. The method of transmitting a frame of claim 15, further comprising:
allocating some of the low latency region as a data region for data transmission of a low latency terminal; and
transmitting information on the data region through control signaling of the low latency region.

20. The method of transmitting a frame of claim 19, further comprising:
performing HARQ feedback through a control region or a data region of the legacy system band in the case in which resources for performing a HARQ procedure in the low latency region are insufficient at the time of performing the HARQ feedback of a transport block transmitted through the data region.
